(19) United States
(12) Patent Application Publication
(10) Pub. No.: US 2009/0245273 A1
(43) Pub. Date: Oct. 1, 2009

(54) FRAME TRANSMISSION DEVICE AND CONTROL METHOD FOR THE SAME

(76) Inventor: NOBUHARU GOTOU, Tokyo (JP)

Correspondence Address: NEC CORPORATION OF AMERICA, 6535 N. STATE HWY 161, IRVING, TX, 75039, US

(21) Appl. No.: 12/410,679

(22) Filed: Mar. 25, 2009

(30) Foreign Application Priority Data
Mar. 27, 2008 (JP) 2008-083049

(51) Int. Cl. H04L 12/413

(52) U.S. Cl. 370/445

(57) ABSTRACT

A problem is solved in that a transmission path is continually used even if multiple collisions occur in the frame transmission device. An Ethernet transmission device 1 includes a PHY/MAC block 3 for transmitting/receiving a frame. The device 1 also includes the collision monitoring unit 8 for detecting the occurrence of a collision in the PHY/MAC block 3 and counting the number of collision frames encountered collisions; and a main signal link control unit 9 for performing link-down control on the PHY/MAC block 3 if the number of collision frames being counted per unit time exceeds a pre-determined threshold.

This application is based upon and claims the benefit of priority from Japanese patent application No. 2008-083049, filed on Mar. 27, 2008, the disclosure of which is incorporated herein in its entirety by reference.

### BACKGROUND OF THE INVENTION

1. Field of the Invention

The present invention relates to a frame transmission device and a control method for the same, and particularly to link control on the occurrence of multiple frame collisions on a transmission path.

2. Description of the Related Art

Japanese Patent Laid Open Publications Nos. 05-091093, 07-023043 and 10-056470 are documents that disclose the arts related to the present invention. Japanese Patent Laid Open Publication No. 05-091093 discloses a technique to improve communication reliability by automatically switching, when a transmission path fails that is currently used, to the other transmission path. Referring to paragraphs 0009 to 0011 and paragraphs 0016 to 0020 of the document, the current path is switched to a redundant transmission path being connected to the same unit if a safety test (link integrity) finds out abnormality.

Referring to paragraphs 0011, 0012, 0022, and 0054 to 0057 of Japanese Patent Laid Open Publication No. 07-023043, a hub unit including a plurality of ports separates a receiving port if a transmission path monitoring control unit detects a pre-determined number of continual collisions or more in the receiving port by a hub control unit.

Referring to paragraphs 0027 to 0033 of Japanese Patent Laid Open Publication No. 10-056470, a network communication control device detects the occurrence of a collision on a communication line, counts the number of occurred collisions during a certain time, and extends a -data transmission waiting time to resolve the occurrence of multiple collisions when the number of collisions is larger than a number being set.

### SUMMARY OF THE INVENTION

IEEE 802.3 standard Ethernet (registered trademark) communication schemes include two kinds of schemes, i.e., full duplex communication and half duplex communication. The full duplex communication is tow-way simultaneous communication, while half duplex communication is alternate communication, in which both opposing Ethernet transmission devices being connected is set to the same communication scheme. An auto-negotiation function is known of automatically fitting a communication scheme to an opposing Ethernet connected device by determining whether the opposing device is adapted to full duplex or half duplex. Ethernet transmission devices can include a device being fixed to full duplex setting, a device being fixed to half duplex setting, as well as a device being adapted to the auto-negotiation.

Between auto-negotiation adaptive devices opposing to each other, the devices automatically select the same scheme as their communication scheme by a priority resolution function. However, where an auto-negotiation adaptive Ethernet transmission device and an Ethernet transmission device being fixed to full duplex setting oppose to each other, the former device fails in auto-negotiation because the latter device is not adapted to auto-negotiation. This leads the former device to half duplex communication being a regular standard at an auto-negotiation failure, resulting in a communication scheme being different from that of the opposing device. A time to send out a frame is not considered since one of the devices performs full duplex communication, frames from the both collide in an Ethernet transmission path between the both devices.

If a collision occurs, the frame is not transmitted in half duplex communication, while the collision is not detected and the frame is kept to be transmitted in full duplex communication. In this case, frame transmission from a device in full duplex communication is given priority. This may cause a communication error in that a device in half duplex communication cannot transmit a frame while the device in full duplex communication transmits a frame. A conventional Ethernet transmission device normally operates in such a situation.

As described in the above, the conventional auto-negotiation has the following problems.

A first problem is: an auto-negotiation fails in Ethernet connection between an Ethernet transmission device being adapted to auto-negotiation and an Ethernet transmission device being fixed to full duplex setting. As a result, half duplex communication is used as a communication scheme of the Ethernet transmission device being adapted to auto-negotiation, thereby different communication schemes are used: full duplex communication for one device and half duplex communication for the other device. Therefore, the device being set to half duplex communication detects continual collisions and cannot transmit data while the other device being set to full duplex communication continues to transmit new data.

As a second problem, the transmission path is kept to be used in the above state.

In view of the above, it is an object of the present invention to provide a frame transmission device to solve the second problem.

To achieve the above object, the present invention is characterized by the following configuration.

A frame transmission device according to the present invention is a frame transmission device including a transmission/reception unit that transmits/receives a frame, the frame transmission device further including: a collision monitoring unit that detects the occurrence of a collision in the transmission/reception unit, and counts the number of collision frames which have encountered collisions; and a link controlling unit that performs link-down control on the transmission/reception unit if the number of collision frames being counted per unit time exceeds a pre-determined threshold.

A control method for a frame transmission device according to the present invention is a control method for a frame transmission device including a transmission/reception unit that transmits/receives a frame, the control method including: detecting the occurrence of a collision in the transmission/reception unit; counting the number of collision frames which have encountered collisions; and performing link-down control on the transmission/reception unit if the number of collision frames being counted per unit time exceeds a pre-determined threshold.

According to the present invention, a frame transmission device can be provided to solve a problem in that a transmission path is continually used even if multiple collisions occur in the frame transmission device.

### BRIEF DESCRIPTION OF THE DRAWINGS

FIG. 1 is a block diagram showing the configuration according to an exemplary embodiment of the present invention; and

FIG. 2 is a block diagram showing configuration of major components according to the exemplary embodiment of the present invention.

### EXEMPLARY EMBODIMENT

The following will describe an exemplary embodiment of the present invention.

A scheme to control a link according to this embodiment on the occurrence of multiple frame collisions on an Ethernet transmission path is characterized by having a function of automatically bringing an Ethernet port being connected to an Ethernet transmission path to a link-down state when multiple Ethernet frame collisions occur on the transmission path in a device (a frame transmission device) for transmitting Ethernet data. The scheme thus can prevent continual use of a transmission path in an error state of the occurrence of multiple collisions. The following is more detailed description with reference to the drawings.

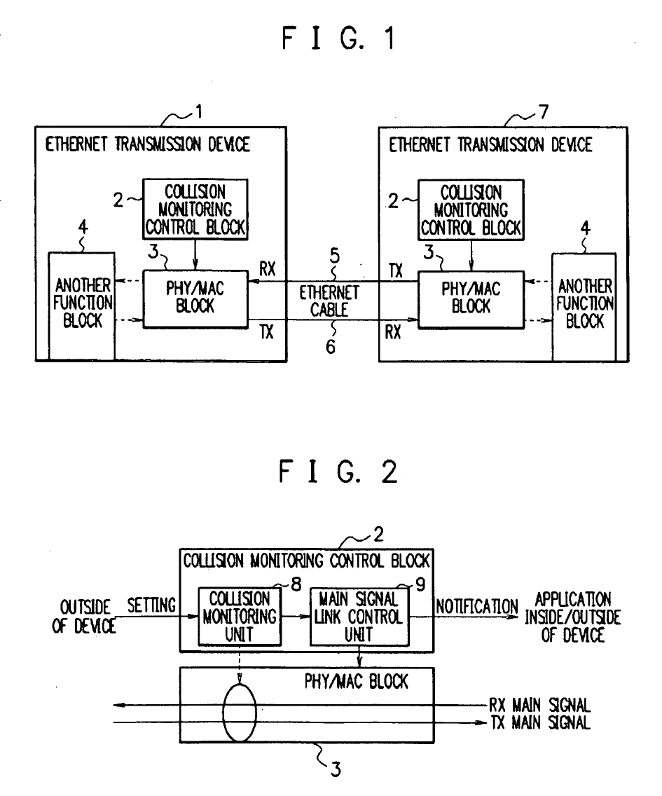

FIG. 1 shows the overall configuration including an Ethernet transmission device 1 according to this embodiment. The Ethernet transmission device 1 is a device for transmitting Ethernet data. An Ethernet transmission device 7 is also a frame transmission device according to this embodiment, to which a different reference numeral is given to ease the description. The Ethernet transmission device 7 is an opposing device to the Ethernet transmission device 1. The Ethernet transmission device 1 and the Ethernet transmission device 7 are physically connected through Ethernet cables 5 and 6.

In FIG. 1, a collision monitoring control block 2 has the following monitoring/controlling functions:

a function of monitoring the occurrence of a collision in a main signal,

a function of counting the number of collision frames,

a function of setting a threshold of the number of collision frames from the outside of the device,

a function of controlling a main signaling link to a PHY/MAC block 3 if the number of collision frames exceeds the above threshold, and

a function of notifying a unit for processing notification to the inside and outside of the device of the state by the collision monitoring control block 2 when link down occurs.

In FIG. 1, the PHY/MAC block 3 is a block for transmitting/receiving an Ethernet frame. That is, the PHY/MAC block 3 functions as a transmission/reception unit, according to this embodiment.

In FIG. 1, another function block 4 can be any block that is decided according to specifications for the use of each Ethernet transmission device, and is not related to the major configuration of this embodiment.

In FIG. 1, the Ethernet cables 5 and 6 are typical cables being Ethernet transmission paths between the Ethernet transmission device 1 and the Ethernet transmission device 7. Standards such as 10 BASE-T/100 BASE-TX are used, for example.

In FIG. 1, the Ethernet transmission device 7 is an Ethernet transmission device being connected to the Ethernet transmission device 1 via the Ethernet transmission paths.

In FIG. 1, the Ethernet transmission device 1 being connected to the Ethernet transmission paths (the Ethernet cables 5 and 6) has a function of monitoring the number of collision frames in an Ethernet port being connected to the transmission paths in the collision monitoring control block 2. In the Ethernet transmission device 1, if in the Ethernet transmission paths, Ethernet frame collisions occur and the number of collision frames exceeds a particular threshold being decided in external input to the Ethernet transmission device 1, the collision monitoring control block 2 sends out a link-down control signal to the PHY/MAC block 3 connected to the relevant Ethernet transmission paths to change from link up to link down.

This embodiment operates as described in the above. That is, even if a failure of multiple collisions occurs in an Ethernet network connecting to the Ethernet transmission device 1 according to this embodiment, the Ethernet transmission device 1 can be automatically brought to a link-down state, so that the device can be separated from the Ethernet network being unusual because of the occurrence of multiple collisions.

FIG. 2 shows detailed configuration of the collision monitoring control block 2 shown in FIG. 1 and the configuration of its peripheral block.

In FIG. 2, a collision monitoring unit 8 monitors a collision of an Ethernet main signal in the PHY/MAC block 3; if it detects a collision, it counts the number of collision frames. The unit 8 resets a count value if no collision is counted during a certain preset time.

In FIG. 2, if the collision monitoring unit 8 detects a collision and a collision frame counter value per unit time exceeds a certain threshold, a main signal link control unit 9 sends out a control signal to bring a link of the Ethernet main signal to a down state to the PHY/MAC block 3.

In FIG. 1, if a collision of the Ethernet main signal occurs in the Ethernet cables 5 and 6, the collision monitoring control block 2 detects the collision through the PHY/MAC block 3. Specifically, the collision monitoring unit 8 in FIG. 2 detects the collision and counts the number of collision frames.

If collisions occur sequentially and the number of collision frames exceeds a certain threshold being preset by the outside of the device, the main signal link control unit 9 controls to bring the PHY/MAC block 3 to a link-down state. At the same time, the unit 9 notifies applications in the inside of the device or the outside of the device of link down notification. The unit 9 resets a count value if no collision is counted during a certain time being preset.

The link down is notified to an upper layer protocol (inside of the device), an application (outside of the device), and an opposing device (outside of the device). This produces a significant effect in that network administrators of both of the Ethernet transmission device 1 and the opposing device can immediately find and deal with abnormality. For switching after link disconnection of the Ethernet transmission device 1, the link disconnection can help to easily execute route changing to a route that does not use the Ethernet transmission device 1.

The configuration of this embodiment has been discussed in detail in the above. The PHY/MAC block 3 and the other function block 4 in FIG. 1 are well known to those skilled in the art and are not directly related to the present invention, of which detailed configuration (a block diagram) is omitted.

This embodiment described in the above produces effects as follows.

As a first effect, an Ethernet port is brought to a link-down state that is connected to a transmission path which has encountered multiple collisions when multiple collisions occur on an Ethernet transmission path, so that it is possible to prevent continual use of a transmission path in an unusual state with the occurrence of multiple collisions.

As a second effect, an Ethernet port is brought to a link-down state that is connected when the multiple collisions occur on an Ethernet transmission path, so that applications in the inside of the device or the outside of the device can be notified of the link down.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### DESCRIPTION OF REFERENCE NUMERALS

1 Ethernet transmission device
2 Collision monitoring control block
3 PHY/MAC block
4 Another function block
5, 6 Ethernet cables
7 Ethernet transmission device
8 Collision monitoring unit
9 Main signal link control unit

What is claimed is:

1. A frame transmission device comprising transmission/reception unit that transmits/receives a frame, the device further including:
a collision monitoring unit that detects the occurrence of a collision in the transmission/reception unit, and counts the number of collision frames which have encountered collisions; and
a link controlling unit that performs link-down control on the transmission/reception unit if the number of collision frames being counted per unit time exceeds a pre-determined threshold.

2. The frame transmission device according to claim 1, wherein the link controlling unit notifies at least one of inside of the device and outside of the device of the link down when performing the link-down control.

3. The frame transmission device according to claim 2, wherein the notification is made to at least one or more of an upper layer protocol, an external application for using the frame transmission device, and an opposing device to the frame transmission device.

4. A control method for a frame transmission device comprising transmission/reception unit that transmits/receives a frame, the method including:
detecting the occurrence of a collision in the transmission/reception unit;
counting the number of collision frames which have encountered collisions; and
performing link-down control on the transmission/reception unit if the number of collision frames being counted per unit time exceeds a pre-determined threshold.

5. The control method for a frame transmission device according to claim 4, including notifying at least one of inside of the device and outside of the device of the link down when performing the link-down control.

6. The control method for a frame transmission device according to claim 5, wherein the notification is made to at least one or more of an upper layer protocol, an external application for using the frame transmission device, and an opposing device to the frame transmission device.

7. A frame transmission device comprising transmission/reception means for transmitting/receiving a frame, the device further including:
collision monitoring means for detecting the occurrence of a collision in the transmission/reception means, and counting the number of collision frames which have encountered collisions; and
link controlling means for performing link-down control on the transmission/reception means if the number of collision frames being counted per unit time exceeds a pre-determined threshold.
